(19) United States
(12) Patent Application Publication
(10) Pub. No.: US 2022/0375653 A1
(43) Pub. Date: Nov. 24, 2022

(54) GROUND SHIELD BRIDGE

(71) Applicant: Solaredge Technologies Ltd., Herzeliya (IL)

(72) Inventor: Francesco Guarino, Perugia (IT)

(21) Appl. No.: 17/750,488

(22) Filed: May 23, 2022

Related U.S. Application Data
(60) Provisional application No. 63/192,361, filed on May 24, 2021.

(51) Int. Cl. H01B 9/02; H01B 13/22

(52) U.S. Cl. CPC H01B 9/028; H01B 13/22

(57) ABSTRACT

Described herein are methods, devices, and systems for electrically connecting a plurality of shielded cable shields using a shield bridge conductor embedded in a polymer structure. The shield bridge conductor may electrically connect the cable shields of two or more phase conductor cables and a ground conductor cable.

### CROSS-REFERENCE TO RELATED APPLICATIONS

This application claims priority to U.S. Provisional Patent Application Ser. No. 63/192,361, filed May 24, 2021, entitled “Integrated Ground Shield,” which is incorporated by reference in its entirety in this disclosure.

### BACKGROUND

High voltage conductor cables may be connected between a power supply and a load. These high voltage conductor cables may include one or more phase conductor cables configured to conduct one or more phases of electricity (e.g., multiple conductor cables may be configured to conduct different phases of electricity). The one or more phase conductor cables may be used to transfer power (e.g., a three-phase power transfer). These high voltage conductor cables may cause electromagnetic interference (EMI), for example the high voltage conductor cables in electric vehicles.

### SUMMARY

The following is a short summary of some of the inventive concepts for illustrative purposes only and is not an extensive overview, and is not intended to identify key or critical elements or to limit or constrain the inventions and examples in the detailed description. One skilled in the art will recognize other novel combinations and features from the detailed description.

Described herein are methods, devices, and systems for integrating and electrically connecting cable shields of conductor cables. A cable shield may surround a conductor cable to prevent the effects of electromagnetic interference (EMI) by grounding the shield to an electrical ground, such as to chassis ground, to earth ground, or the like. The cable shields may be electrically connected using a multi-phase ground shield bridge that includes a shield bridge conductor embedded in a polymer structure. The shield bridge conductor may electrically connect the cable shields of two or more power conductor cables of the multi-phase shield bridge and a ground conductor cable of the multi-phase ground shield bridge. The ground conductor cable may be configured to be connected to an electrical ground.

The methods, devices, and systems described herein may integrate and electrically interconnect shielding, such as formed in shielded cables. By surrounding a conductor with shielding, the effects of electromagnetic interference (EMI) may be alleviated, especially in a multi-phase cable configuration. By electrically connecting the respective shielding to an electrical ground (such as to chassis ground, to earth ground, or the like), shielding functionality may be further improved. By directly interconnecting the shielding of different cables (not via common ground), the overall construction can be simplified and more effective. For example, the shielding of a first cable can be directly connected to the shielding of a second cable, e.g. via a shield bridge conductor. This may provide a particularly short and effective conductive path. Furthermore, a single ground conductor cable can be used to ground the respective shielding of two or more cables. When using shielded cables conducting different phases, a multi-phase ground shield bridge configuration may be formed. By embedding at least part of the configuration, such as the shield bridge conductor, in a polymer or other embedding structure, a more reliable construction may be formed. Part of the shield bridge configuration may be integrated in a power device. e.g. one or more of an electrical power supply, inverter, converter, load, et cetera. For example, the conductors of the shield bridge configuration may be electrically connected to different phases of the power device. By electrically connecting the ground conductor cable of the shield bridge configuration with a shielding or ground of the power device, further improvements in reliability and efficiency may be achieved. By attaching or integrating the shield bridge configuration with a housing of the power device, a particularly compact and reliable assembly may be formed.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures. In the drawings, like numerals reference similar elements.

FIG. 1 shows, schematically, a cross-section view of an example multi-phase ground shield bridge including shield bridge conductors.

FIG. 2 shows, schematically, an isometric view of an example multi-phase ground shield bridge structure.

FIG. 3 shows, schematically, a side view of an example multi-phase ground shield bridge structure.

FIG. 4 shows, schematically, an end view of an example multi-phase ground shield bridge structure.

FIG. 5 shows, pictorially, a method of manufacturing an example multi-phase ground shield bridge structure.

FIG. 6 shows a flowchart of a method of manufacturing an example multi-phase ground shield bridge structure.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

Disclosed herein are systems, methods, and devices for electrically connecting cable shields of multiple high voltage conductor cables, also referred to herein as power conductor cables, using a ground shield bridge. Power conductor cables may connect between one or more power sources and one or more loads, where each cable has a cable shield surrounding the power conductor cable. The multiple power conductor cables may conduct different phases of electricity. A shield bridge conductor integrated in a ground shield bridge may electrically connect the cable shields of the multiple power conductor cables to each other. The shield bridge conductor may be embedded in a polymer structure connectable to and/or integrated with a housing of one or more sources and/or one or more loads. For example, the polymer structure may form a tooth shape structure protruding from the housing of an electric traction motor. For example, a ground conductor cable may ground both the shield bridge conductor and the housing of the one or more sources and/or the one or more loads. For example, the ground shield bridge is integrated into the power wires leaving the inverter of an electric vehicle. For example, a ground shield bridge may electrically connect, using the shield bridge conductor, the cable shields and the ground conductor cable, thereby protecting the power cables from emitting electromagnetic interference (EMI).

In a preferred implementation, parts of the systems and devices as described herein may be manufactured from shielded cables. A shielded cable or screened cable typically has a common conductive layer around its conductors for electromagnetic shielding with insulating material there between (inner insulating layer). This shield is usually covered by an outermost insulating layer of the cable. Common types of cable shielding can be categorized as foil type (metallized film), wire strands (braided or unbraided), or both. As used herein, preferably a cable shielding based on wire strands is used. A portion of the outer insulation may be stripped from each cable to expose a respective shield portion of the cable shield, e.g. wire strands and/or film. For each cable, the exposed shield portion may be pulled from the rest of the cable to form a piece of conductive shield wiring electrically connected to a remaining portion of the cable shield. The shield wirings of the cables may be electrically interconnected such that a shield bridge conductor is formed between the cable shields of the plurality of shielded cables. Optionally, a terminal lug may be connected to an end of the interconnected shield wiring to form a ground conductor cable. Preferably, the shield wirings are re-insulated. This may include insulating parts of the shield bridge, ground conductor cable, and/or encapsulating at least part of the shield bridge configuration in an embedding structure. Preferably at least the shield bridge conductor and electrical connections/bondings to the cable shielding are embedded. For example, the configuration may be at least embedded in a polymer structure or other dielectric material which may be connected or integrated with a power device.

The polymer structure may be a resin, thermoplastic, or thermosetting material. The polymer structure may comprise a rigid shell and a potting material. The potting material may allow compliance during assembly and/or molding, a wide operating temperature range, and vibration resistance. The rigid shell may protect the potting material and may provide abrasion resistance.

In a series-connected bridge configuration, the shielding of a first cable may be grounded exclusively via the shielding of a second cable (via the shield bridge conductor there between), so the first cable does not require a direct connection to a ground conductor cable, or separate connection to electrical ground. This may provide a particularly convenient construction. Alternatively, or additionally, the first and second cables may be connected to a single ground conductor cable connected to the shield bridge conductor there between. Also, more than two, e.g. three, cables can be interconnected in this way having a single connection to ground. For example, in a series-connected bridge configuration, the shielding of a first cable may be directly connected to the shielding of a second cable, the shielding of the second cable may be directly connected to the shielding of a third cable, and the shielding of the third cable may be connected to the ground conductor cable (or to a fourth cable, etc.). Advantageously, the series interconnected cables can provide a flat configuration that can be easily constructed and expanded, e.g. around a perimeter of a power device. For example, the shielding of the third cable may be exclusively connected to the shielding of the first cable via the shielding of the second cable and does not require a direct connection or extra wire. Alternatively, or additionally, the shielding of the third cable may be directly connected to the shielding of the first cable and/or the ground conductor cable may be connected anywhere to the shield bridge conductor, e.g. between the first and second cables, between the second and third cables, and/or between the first and third cable.

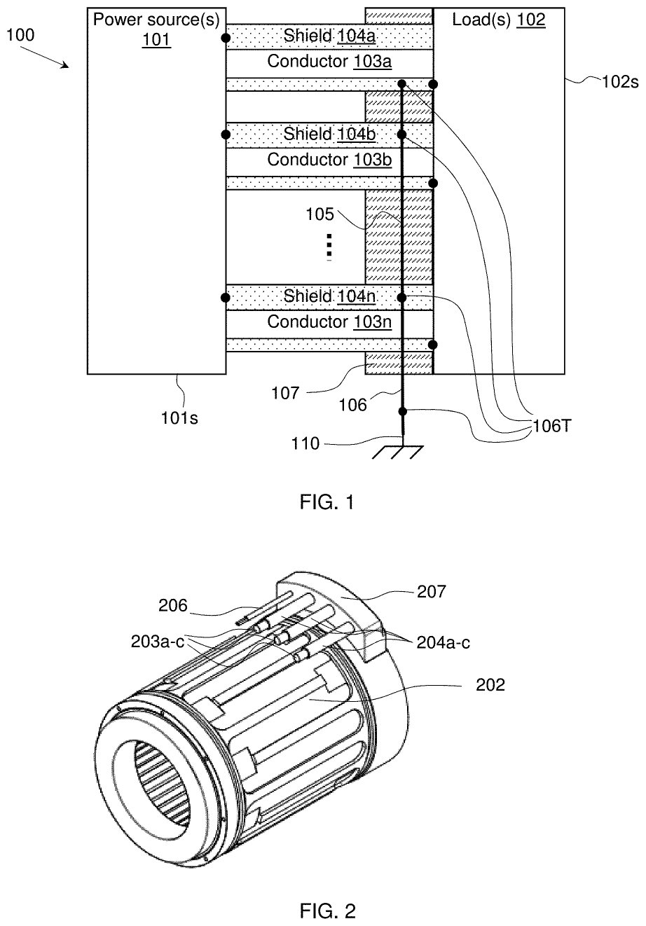

Reference is now made to FIG. 1, which shows, schematically, a cross-section view of an example multi-phase ground shield bridge 100 with a shield bridge conductor 105. The multi-phase ground shield bridge 100 may be also referred to as a shield bridge. The shield bridge 100 may have a plurality of power conductor cables including a plurality of phase conductor cables 103a, 103b, . . . , 103n (where n is any appropriate number e.g., two, three, or more), also referred to as conductors. For the sake of brevity, conductors 103a, 103b, . . . 103n may also be referred to as conductors 103x. The shield bridge 100 may have a plurality of cable shields 104a, 104b, . . . , 104n (where n is any appropriate number, e.g., corresponding to the number of conductor cables), also referred to as shields. For the sake of brevity, shields 104a, 104b, . . . , 104n are also referred to as shields 104x. The conductors 103x may conduct power from one or more power source(s) 101 to one or more load(s) 102. The one or more power source(s) 101 may also be referred to as one or more power supplies. The conductors 103x may be surrounded by, or encapsulated by, a respective cable shield of the shields 104x. Shields 104x may typically comprise or consist of electrically conductive or other EMI shielding material which may be electrically connected at one end to the power source housing 101s. The power source housing 101a may act as or include an EMI shield for the source the power sources 101. Additionally, or alternatively, shields 104x may be electrically connected at another end to the load housing 102s, and the load housing 102s may act as or include an EMI shield for the loads 102. A shield bridge conductor 105 may be used to electrically connect the shields 104x together. For example, the shields 104x may be connected by using bonds 106T. Bonds 106T may provide electrical connection (e.g., a short circuit) between two conductors, and the electrical connections may be produced using welding, solder, screw terminals, push terminals, spring connectors, braiding, twist on wire connectors, conducting glue, spring wire connectors, etc. Bonds 106T may be connected to shields 104x. Bonds 106T may be permanently and/or electrically connected to shields 104x, such as with solder, welding, rivets, adhesive bonding, etc. Alternatively, bonds 106T may be reversibly connected to shields 104x, such as with lugs, bolts, screws, terminals, etc. The shield bridge conductor 105 is also referred to as a conducting shield bridge, an electrical shield bridge, a conducting bridge, or jumper. Shield bridge conductor 105 may include one or more conducting bridge cables connected between a plurality of bonds 106T. A ground conductor cable 106 may be extended from the shield bridge conductor 105 to a ground terminal 110. Conductor cable 106 may be connected between one of bonds 106T and ground terminal 110. Shield bridge conductor 105 may be embedded in a polymer structure 107, such as a tooth shaped resin structure, a shell with potting material, a thermoplastic material, or the like. Polymer structure 107 may also be referred to as an encapsulation, resin assembly, housing, or multi-phase shield bridge structure. In some examples, the polymer structure 107 may encapsulate a length of the conductors 103x that may be at least partially without shields. In some examples, the polymer structure 107 may encapsulate at least a portion of the shield bridge conductor 105. The ground conductor cable 106 may connect the polymer structure 107 (e.g., of one or more power sources and/or one or more loads) to the ground terminal 110 (e.g., the chassis ground terminal of an electric vehicle).

In the example of FIG. 1 there are shown three phase conductors 103a, 103b, 103n, with three respective cable shields 104a, 104b, 104n. The three phase conductors 103a, 103b, 103n may be configured to conduct three phase power from the one or more power source(s) 101 to the one or more load(s) 102. Also, other numbers of phases can be used, e.g. two, four, or more.

Reference is now made to FIG. 2, which shows, schematically, an isometric view of an example polymer structure 207 (e.g., the polymer structure 107). An electric traction motor 202 may have multiple conductors 203a, 203b, or 203c each surrounded or encapsulated by a respective one of multiple shields 204a, 204b, or 204c. A bridge (not shown) may be an extension of a ground conductor cable 206 (e.g., the ground conductor cable 106) and encased in a polymer structure 207. An element shown in one figure with one reference number and in a different figure with a different number may be the same or similar element. For example, conductors 103x and conductors 203x may be the same conductors, shields 104x and shields 204x may be the same shields, structure 107 and structure 207 may be the same structure, etc. The same is true throughout the figures herein.

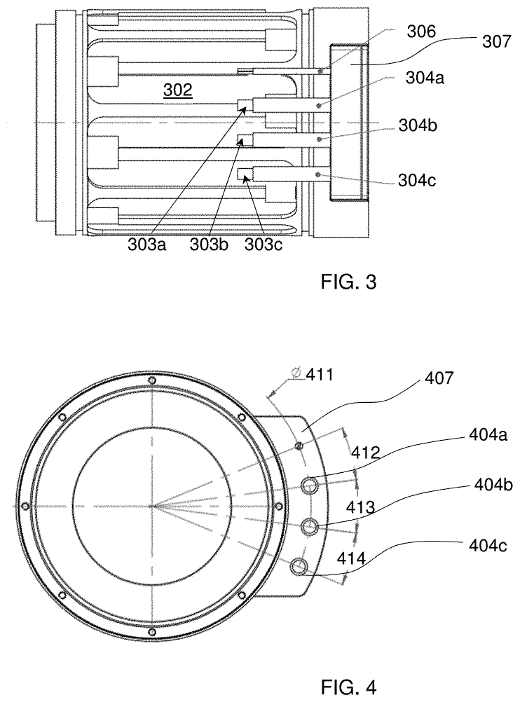

Reference is now made to FIG. 3, which shows, schematically, a side view of an example polymer structure 307 (e.g., the polymer structure 107 or 207). An electric traction motor 302 (e.g., the electric traction motor 202) may have multiple conductors 303a, 303b, or 303c each surrounded or encapsulated each by a respective one of multiple shields 304a, 304b, or 304c. A bridge may be an extension of a ground conductor cable 306 (e.g., the ground conductor cable 106 or 206)) and encased in a polymer structure 307.

Reference is now made to FIG. 4, which shows, schematically, an end view of an example polymer structure 407 (e.g., the polymer structure 107, 207 or 307). Each conductor 404a, 404b, or 404c may be positioned at a radius 411 from motor axis, and each conductor 404x exiting the polymer structure 407 may be oriented relative to the other conductors 404x with angles 412, 413, or 414.

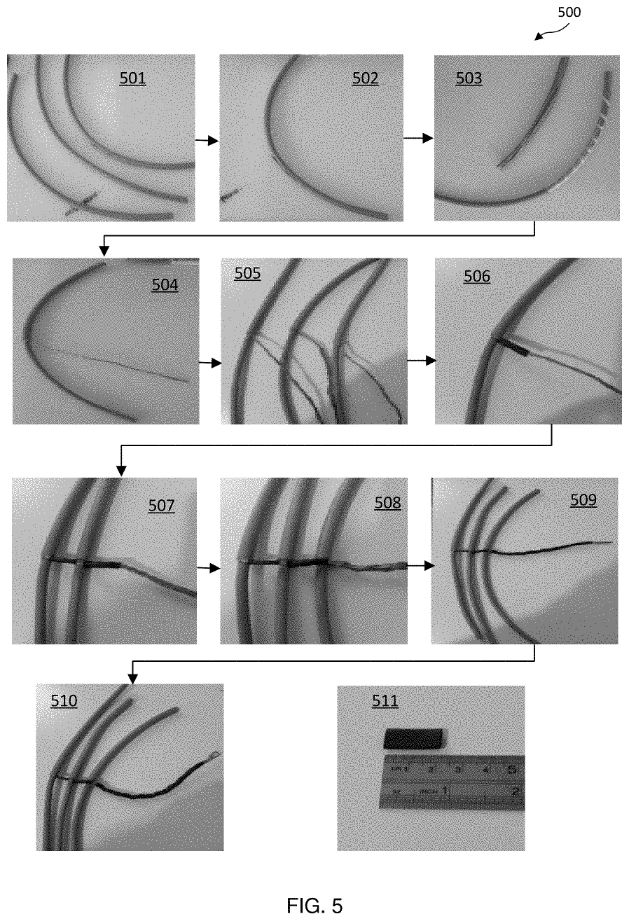

Reference is now made to FIG. 5, which shows, pictorially, a method of manufacturing 500 an example multi-phase shield bridge. A cutting step 501 defines multiple conductors (such as one for each phase) cut to a predetermined length. For example, step 501 illustrates three conductors of substantially the same length. In some examples, the lengths of the multiple conductors may be different. Each conductor may be cut from an insulated and/or shielded conductive cable. For example, the cable initially comprises a conductive core surrounded by an inner insulation layer, surrounded by electrically conductive shielding, or surrounded by an outer insulation layer. Also, other or further layers may be provided. In insulation stripping steps 502 and 503, at least part of each conductor's shields may be exposed or stripped (e.g., by removing part of an outer insulation layer or shield), forming a plurality of stripped conductors. A strip of shield (e.g., a shielding wire surrounding an inner insulation layer) may be partially separated (e.g., pulled) from the each conductor at separating step 504 or 505. A shield bridge conductor may be formed between the strips of shields (e.g., shielding wires) at steps 506, 507, or 508, where each of the strips of shields may be further insulated (e.g., with a section of shrink tubing 511) forming a plurality of re-insulated strips of shields or shielding wires, and each re-insulated strip of shield may be electrically connected (such as soldered) to the neighboring strip of shield (while remaining insulated from the conductive core). A remaining strip of shield (e.g., shielding wire) of the shield bridge conductors may be insulated at step 508 (e.g., with further shrink tubing), to provide a ground conductor cable for connecting to a ground, such as earth ground or chassis ground. A terminal lug may be connected to the end of the remaining shield conductor cable/ground conductor cable as at step 510. During installation, the lug may be connected to a ground terminal, such as an earth ground terminal in a residence or building or such as a chassis ground of a vehicle. The shield bridge conductor may then be encapsulated in a polymer structure configured to be integrated with one or more power sources and/or one or more loads (such as integrated with the housing of the source or load).

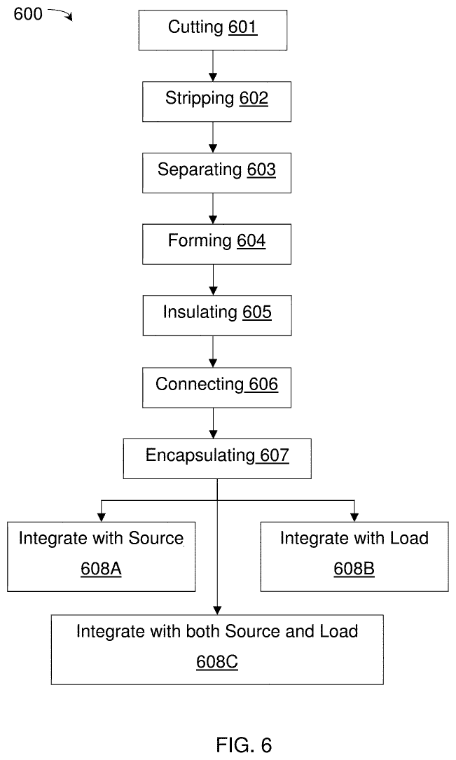

Reference is now made to FIG. 6, which shows a flowchart 600 of a method of manufacturing an example multi-phase ground shield bridge structure. A cutting step 601 may comprise multiple cables (such as one for each phase) being cut to one or more predetermined lengths. The cables may comprise insulated and/or shielded conductive cable (e.g., conductors 103x with shield 104x, conductors 203x with shields 204x, conductors 303x with shields 304x). Additionally, the conductors may comprise an inner insulating layer between the conductor and the cable shield, and/or an outer insulating layer surrounding the cable shield. In stripping step 602, at least part of each conductor's shields may be stripped or cut off, forming a plurality of stripped shields. In some examples, stripping a part of a conductor's shield may comprise stripping a portion of the outer insulation from the cable to expose the shield. Stripped shields may be separated from the conductors as at separating step 603. The separating step may comprise pulling the exposed shield portion from the rest of the cable to form a piece of conductive shield wiring electrically connected to the remaining portion of the cable shield. At step 604, a shield bridge conductor may be formed by twisting together and soldering the separated shield wirings of step 603. Additionally, each of the shield wirings may be insulated (as with a section of shrink tubing 511) forming a plurality of re-insulated conductors, and each shield wiring of the shields of the re-insulated conductors is electrically connected (such as soldered) to the neighboring shield wiring. Any or some of the remaining shield wirings of the shield bridge conductor may be insulated as at step 605, and used as a ground conductor cable. A terminal lug may be connected to the end of the remaining shield conductor cable (ground conductor cable) as at step 606. The shield bridge conductor may then be encapsulated in a polymer structure as in step 607, and integrated with one or more power sources as in step 608A, with one or more loads as in step 608B, or with both as at step 608C.

The manufacturing methods of FIGS. 5 and 6 are examples of a material resource efficient method for low volume production of the shield bridge, but a mass production method may include machine manufacturing a shield bridge conductor with a number of bonding points for each phase's cable shield and the ground conductor cable. For example, four bonding points on the bridge conductor may be prepared by stamping a bridge conductor from a cutting of a copper ingot. The ground conductor cable may be mass produced by cutting a longer cable, and using an automatic terminal lug attachment machine to attach the terminal lug. For example, a robot may be used to attach a terminal lug. The shield bridge conductor and ground conducting cable may be electrically connected, such as with soldering, bonding, and/or by using a machine. A polymer structure may be manufactured (such as by potting, encapsulating, overmolding, etc.) around the shield bridge conductor and ground conducting cable bonding points. The polymer structure may be configured to (such as having a special shape) be integrated into a device that is connected to power cables, such as a power source or a load. For example, the housing (of a source or load) may include a cavity shaped to accept at least part of the polymer structure, thereby securing the shield bridge to the housing.

Although the shield bridge examples herein show integration in the housing's of loads, the shield bridge may be configured to be integrated into the housing's of a power sources. For example, a shield bridge may be integrated in the housing of a power inverter used to provide power to an electric motor. For example, a shield bridge may be integrated in the housing of an electrical storage device used to provide power to a power inverter. For example, a shield bridge may be integrated in the housing of a battery charger used to provide power to an electrical storage device. Some devices may be considered both load and sources, but at least one shield cable is required for each interconnection between devices.

In cases where high reliability is specified, a shield bridge may be integrated into a plurality of devices that are interconnected with power cables. For example, when a single power source and single load are electrically connected, shield bridges may be integrated into the housings of both the power source and load. For example, when a single power source and multiple loads are electrically connected, shield bridges may be integrated into the housings of at least some of the power source and loads. For example, when a multiple power sources and multiple loads are electrically connected, shield bridges may be integrated into the housings of at least some of the power source and loads.

The multi-phase shield bridge may provide many benefits over other solutions. By integrating two or more of the shields using the multi-phase shield bridge only one ground conductor cable may be needed to ground a plurality of shields of the conductors and one or more housings of the one or more loads/sources. This may allow relatively simpler product assembly and relatively larger mean time between failures due to fewer parts. The integrated polymer structure may encapsulate the shield bridge conductor and bonding points with the cable shields and ground conductor cable. For example, the polymer structure may provide a moisture and dust barrier to the conductors, bonding points, and attached housing. The polymer structure may also mechanically secure the bonds between the multi-phase shield bridge and each cable shield, and may prevent failures, such as a mechanical failure of the ground conductor cable. For example, the polymer structure may provide strain relief of the bonding points from the mechanical forces on the cables. The benefits of protection from the environment using the polymer structure may increase the maintenance time intervals, decrease the mean time between failures, and produce a more reliable product.

Specific dimensions, specific materials, specific ranges, specific resistivities, specific voltages, specific shapes, and/or other specific properties and values disclosed herein are by example and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter. For example, the disclosure of a first value and a second value for a given parameter can be interpreted as disclosing that any value between the first and second values could also be employed for the given parameter. For example, if parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

In the description of various illustrative features, reference is made to the accompanying drawings, which form a part hereof, and in which is shown, by way of illustration, various features in which aspects of the disclosure may be practiced. It is to be understood that other features may be utilized and structural and functional modifications may be made, without departing from the scope of the present disclosure.

Terms such as “multiple” as used in this disclosure indicate the property of having or involving several parts, elements, or members. The term “multiple” used herein may be interchangeable with the term “plurality”.

It may be noted that various connections are set forth between elements herein. These connections are described in general and, unless specified otherwise, may be direct or indirect; this specification is not intended to be limiting in this respect, and both direct and indirect connections are envisioned. Further, elements of one feature in any of the embodiments may be combined with elements from other features in any of the embodiments, in any combinations or sub-combinations.

All described features, and modifications of the described features, are usable in all aspects of the inventions taught herein. Furthermore, all of the features, and all of the modifications of the features, of all of the embodiments described herein, are combinable and interchangeable with one another. For example, it will be understood that aspects described with reference to FIG. 1 may also be applicable to any of FIGS. 2-4, and vice versa, e.g. with like numerals reference describing the same or similar elements. Similarly, it will be understood that methods, e.g. as described with reference to FIGS. 5 and 6, may be used for constructing systems, sub-systems, devices, components thereof, et cetera, e.g. such as described with reference to any of FIGS. 1-4. Accordingly, aspects described with reference to the respective methods may have corresponding aspects in the resulting products, and vice versa.

Clauses:

Clause 1: An apparatus, comprising:
a plurality of conductors, wherein each conductor of the plurality of conductors is configured to conduct a different phase of a multi-phase power source;
a plurality of cable shields, wherein each cable shield of the plurality of cable shields is configured to surround a respective one of the plurality of conductors; and
a shield bridge comprising:
a polymer structure,
a shield bridge conductor,
a ground conductor cable, and
a plurality of bonds,
wherein each bond of the plurality of bonds is electrically connected to a respective cable shield of the plurality of cable shields, and
wherein the shield bridge conductor is connected to the plurality of bonds and the ground conductor cable such that a short circuit is created between the plurality of cable shields using the shield bridge conductor.

Clause 2: The apparatus of clause 1, wherein the plurality of conductors comprises three conductors, wherein the plurality of cable shields comprises three cable shields, and wherein the plurality of bonds comprises four bonds.

Clause 3: The apparatus of any one of clauses 1-2, wherein the polymer structure is configured to be integrated with a housing of the multi-phase power source or a load.

Clause 4: The apparatus of any one of clauses 1-3, wherein the plurality of conductors are configured to supply power from the multi-phase power source to a load.

Clause 5: The apparatus of any one of clauses 1-4, wherein the plurality of cable shields are electrically connected to a power source shield.

Clause 6: The apparatus of any one of clauses 1-5, wherein the plurality of cable shields are electrically connected to a load shield.

Clause 7: The apparatus of any one of clauses 1-6, wherein the ground conductor cable is electrically connected to a ground terminal.

Clause 8: A method, comprising:
cutting a plurality of conductors according to a predetermined length;
stripping a portion of insulation from each conductor of the plurality of conductors to form a plurality of stripped conductors;
separating a shield portion of each cable shield of a plurality of cable shields from each conductor of the plurality of stripped conductors;
electrically connecting an end of at least some of the plurality of stripped conductors to an adjacent stripped conductor of the plurality of stripped conductors, such that a shield bridge conductor is formed;
insulating each conductor of the plurality of stripped conductors to form a plurality of insulated conductors;
connecting a terminal lug to the end of at least one of the plurality of insulated conductors to form a ground conductor cable; and
encapsulating the shield bridge conductor in a polymer structure.

Clause 9: The method of clause 8, wherein the plurality of conductors comprises three conductors, and the plurality of cable shields comprises three cable shields.

Clause 10: The method of any one of clauses 8-9, wherein the polymer structure is mechanically attached to a load.

Clause 11: The method of any one of clauses 8-10, wherein the plurality of conductors supply power from a power source to a load.

Clause 12: The method of any one of clauses 8-11, wherein the plurality of cable shields are electrically connected to a power source shield.

Clause 13: The method of any one of clauses 8-12, wherein the plurality of cable shields are electrically connected to a load shield.

Clause 14: The method of any one of clauses 8-13, wherein the terminal lug is electrically connected to a ground terminal.

Clause 15: A power device, comprising:
a plurality of conductors, wherein each conductor of the plurality of conductors is configured to conduct a different phase of a multi-phase power source;
a plurality of cable shields, wherein each cable shield of the plurality of cable shields is configured to surround a respective one of the plurality of conductors; and
a housing comprising:
a shield bridge comprising:
a polymer structure,
a shield bridge conductor,
a ground conductor cable, and
a plurality of bonds,
wherein each bond of the plurality of bonds is electrically connected to a respective cable shield of the plurality of cable shields, and
wherein the shield bridge conductor is connected to the plurality of bonds and the ground conductor cable such that a short circuit is created between the plurality of cable shields using the shield bridge conductor.

Clause 16: The power device of clause 15, wherein the plurality of conductors comprises three conductors, wherein the plurality of cable shields comprises three cable shields, and wherein the plurality of bonds comprises four bonds.

Clause 17: The power device of any one of clauses 15-16, further comprising a power source or a load, and the power device comprises a plurality of phases.

Clause 18: The power device of any one of clauses 15-17, wherein the plurality of conductors are configured to supply power from a multi-phase power source to a load.

Clause 19: The power device of any one of clauses 15-18, wherein the housing further comprises a shield, and wherein the plurality of cable shields are electrically connected to the shield.

Clause 20: The power device of any one of clauses 15-19, wherein the ground conductor cable is electrically connected to a ground terminal.

What is claimed is:

1. An apparatus, comprising:
a plurality of conductors, wherein each conductor of the plurality of conductors is configured to conduct a different phase of a multi-phase power source;
a plurality of cable shields, wherein each cable shield of the plurality of cable shields is configured to surround a respective one of the plurality of conductors; and
a shield bridge comprising:
a shield bridge conductor,
a ground conductor cable, and
a plurality of bonds,
wherein each bond of the plurality of bonds is electrically connected to a respective cable shield of the plurality of cable shields, and
wherein the shield bridge conductor is connected to the plurality of bonds and the ground conductor cable such that a short circuit is created between the plurality of cable shields using the shield bridge conductor.

2. The apparatus of claim 1, wherein the plurality of conductors comprises three conductors, wherein the plurality of cable shields comprises three cable shields, and wherein the plurality of bonds comprises four bonds.

3. The apparatus of claim 1, wherein the shield bridge further comprises a polymer structure configured to be integrated with a housing of the multi-phase power source or a housing of a load.

4. The apparatus of claim 3, wherein the plurality of conductors are configured to supply power from the multi-phase power source to the load.

5. The apparatus of claim 1, wherein the plurality of cable shields are electrically connected to a housing of a power source or housing of a load.

6. The apparatus of claim 1, wherein the plurality of conductors are electrically insulated or separated from the plurality of cable shields.

7. The apparatus of claim 1, wherein the ground conductor cable is electrically connected to a ground terminal.

8. A method, comprising:
providing a plurality of shielded cables, each cable comprising a conductor surrounded by a cable shield, with an inner insulation between the conductor and the cable shield, and an outer insulation surrounding the cable shield;
for each shielded cable of the plurality of shielded cables:
stripping, from the shielded cable, a portion of the outer insulation to expose a portion of the respective cable shield;
pulling the exposed portion of the respective cable shield from the cable to form a shield wiring electrically connected to the cable shield;
electrically interconnecting shield wirings of the plurality of shielded cables to form a shield bridge conductor between the plurality of shielded cables; and
connecting a ground conductor cable to an end of the shield bridge conductor.

9. The method of claim 8, wherein the plurality of shielded cables comprises three shield conductors.

10. The method of claim 8, further comprising:
encapsulating at least part of the shield bridge conductor in a polymer structure mechanically attached to a load.

11. The method of claim 8, wherein the plurality of shielded cables supply power from a power source to a load.

12. The method of claim 8, wherein cable shields, of the plurality of shielded cables, are electrically connected to a housing of a power source.

13. The method of claim 8, wherein cable shields of the plurality of shielded cables are electrically connected to a housing of a load.

14. The method of claim 8, wherein the ground conductor cable is electrically connected to a ground terminal.

15. A power device, comprising:
a plurality of conductors, wherein each conductor of the plurality of conductors is configured to conduct a different phase of the power device;
a plurality of cable shields, wherein each cable shield of the plurality of cable shields is surrounded by a respective one of the plurality of conductors; and
a housing comprising:
a shield bridge comprising:
a shield bridge conductor,
a ground conductor cable, and
a plurality of bonds,
wherein each bond of the plurality of bonds is electrically connected to a respective cable shield of the plurality of cable shields, and
wherein the shield bridge conductor is connected to the plurality of bonds and the ground conductor cable such that a short circuit is created between the plurality of cable shields using the shield bridge conductor.

16. The power device of claim 15, wherein the plurality of conductors comprises three conductors, wherein the plurality of cable shields comprises three cable shields, and wherein the plurality of bonds comprises four bonds.

17. The power device of claim 15, further comprising a multi-phase power source and a load.

18. The power device of claim 15, wherein the plurality of conductors are configured to supply power from a multi-phase power source to a load.

19. The power device of claim 15, wherein the housing further comprises a shield, and wherein the plurality of cable shields are electrically connected to the shield.

20. The power device of claim 15, wherein the ground conductor cable is electrically connected to a ground terminal.
